(19) United States
(12) Patent Application Publication
(10) Pub. No.: US 2014/0328630 A1
(43) Pub. Date: Nov. 6, 2014

(54) SYSTEM AND METHOD FOR FACILITATING ACCESS TO UTILITY BOXES

(71) Applicant: ULC ROBOTICS, INC., Bay Shore, NY (US)

(72) Inventor: RYAN McGOWAN, Lindenhurst, NY (US)

(73) Assignee: ULC ROBOTICS, INC., Bay Shore, NY (US)

(21) Appl. No.: 14/270,990

(22) Filed: May 6, 2014

Related U.S. Application Data
(60) Provisional application No. 61/819,806, filed on May 6, 2013.

(51) Int. Cl. F16L 1/028

(52) U.S. Cl. CPC F16L 1/028
USPC 405/184.1

(57) ABSTRACT

A system and method for raising utility boxes includes locating a hidden utility box that is paved over or otherwise covered and not visible from above the ground. A rough locating technique may be used to get within the general vicinity of the box, followed by a more finely tuned locating technique to pinpoint the exact location of the box. With the location accurately known, a system including a core drill is used to cut through the material covering the box, without the need to excavate large areas of roadway or other ground cover. Once having access the utility box, it is extended, raised or replaced such that it is visible and accessible from the then current ground level.

### CROSS-REFERENCE TO RELATED APPLICATIONS

This application claims the benefit of U.S. provisional application Ser. No. 61/819,806 filed 6 May 2013, which is hereby incorporated herein by reference.

### TECHNICAL FIELD

The present invention relates to a method for facilitating access utility boxes.

### BACKGROUND

Utility companies often rely on underground conduits to provide services to their customers. For example, thousands of miles of underground gas pipelines are used to deliver natural gas to homes and businesses throughout the United States. In order to provide access to mechanical or electrical connections to these pipelines, “curb boxes” are installed at various locations along a pipeline route. For example, in the case of a gas pipeline, a curb box may be placed generally flush with ground-level, and may contain a shutoff valve for a portion of the pipeline. Thus, in some cases, these curb boxes are also called “valve boxes”. In the case of a steel pipeline, a sacrificial anode may be placed in electrical contact with the pipeline to inhibit pipeline corrosion. In such cases, the electrical connection between the pipeline in the anode may be terminated in a curb box, which is similarly configured to a valve box.

One common feature of curb boxes, is that they are intended to be accessed with little or no excavation. A top cover of the curb box is generally installed to be relatively level with the surface of the ground, and has a top cover which can be removed to provide access to the interior of the box. Over time, however, topography changes, particularly within municipalities where roadways are continually being paved and repaved. Thus, it is not uncommon for the top of a curb box to be buried under one or more layers of asphalt or other road material. When this occurs, it may be difficult to pinpoint with specificity the location of the curb box, and thus it may be necessary to undertake a relatively expensive and disruptive excavation project in order to find and ultimately access the curb box.

Curb boxes are sometimes located in sidewalks, or along the edges of busy thoroughfares. In cases such as these, it is common for a municipality to require the purchase of a permit to break through the concrete or asphalt covering and surrounding the box. In addition to the purchase price of the permit, it may be necessary for the construction company to post a bond. Drawings of the proposed excavation may need to be submitted, and additional fees are often required. In addition, there is the equipment required for the excavation project itself, which may include a jack hammer, or other impact device, and a backhoe, or other removal equipment, needed to dig the hole and remove the debris after the concrete or asphalt surface is penetrated.

Such a project is not only expensive and time consuming for the company performing it, but is also disruptive to the public. A typical excavation is loud, time consuming, and may cause traffic—pedestrian and/or vehicle traffic—to be rerouted, not only while the curb box is being raised or a new one installed, but afterward during the time the newly-poured replacement concrete or asphalt sets-up. Thus, a need exists for a method of facilitating access to paved-over curb boxes without the need of undertaking a large excavation project, and to further ensure that future access to the box is simplified, by making the level of the curb box generally the same as the then current ground-level.

### SUMMARY

Embodiments of the present invention may include a system and method for facilitating access to utility boxes, which may include one or more of the following steps. A Mains & Service (M&S) plat or area map showing expected curb box locations, or locations of prior service/construction/maintenance for the specific location is acquired to locate the general area of the paved-over box. Using locating equipment the curb box is located using a combination of one or more of the steps described below.

First, the pipeline itself may need to be located. Locators may locate pipelines by inducing an electrical signal of known frequency in the pipeline with a transmitter, and then using a receiver to detect the signal along the pipeline's path. The signal can be induced at the head of service—i.e., where a meter is connected to the pipeline—since the metal piping making the connection to the meter will provide a conductive path for the induced signal. In the case of non-metallic pipe, a tracer wire may be provided and the signal can be induced in it and the non-metallic pipeline located by the receiver.

Once the pipeline is located, the curb box is located. A metal detector may be used to determine the general location of the paved over curb box. Depending on the detector being used, the box may be located to within about a foot of its exact location. Next, ground penetrating radar (GPR) may be used to determine the exact location of the curb box. The GPR unit may be repeatedly swept along the area known to contain the curb box. This allows a technician to locate the edges of the box, and in particular, the four corners. A technician may then mark the perimeter of the box on the pavement with a marker, or a drill or small core drill, which can be used to create small holes in the pavement at the outer corners of the existing box.

Once the curb box is located, a core drill, with a bit large enough to drill around the curb box lid, is centered on the existing paved-over box. A smaller—e.g., in some embodiments a 1 in. or 2 in. diameter core drill—may be used to drill over the center of the box to ensure that the drill is properly aligned to the curb box lid. The asphalt or concrete ring created by the core drill is chipped away and removed using standard hand tools. Additionally, the circular coupon generated by the core drill may be removed as a single piece. All of this occurs without major excavation of the type for which a permit is usually required.

Next, the curb box cover is removed. The curb box is then raised, which may be accomplished in accordance with embodiments of the invention. In at least some embodiments, the existing curb box is left in place and augmented using a plastic, metallic, or other material curb box extension, which is grouted in place flush to street level. In at least some embodiments, the existing curb box is removed and replaced with a new curb box, which is grouted in place flush to street level. In at least some embodiments, the existing curb box is adjusted to sit flush with street level.

Although many curb boxes may be generally square or rectangular, a circular curb box can be used to replace the existing curb box. The circular curb box can be sized to match the core drill diameter and can be grouted in place flush to street level. The circular curb box replacement may have a square hole cut out in its center that could receive the curb box lid, which itself may be square.

At least some embodiments of the invention include a method for facilitating access to a utility box, including locating an underground utility box having a lid from above-ground. The method may further include core-drilling a hole in the ground above the utility box to gain access to the utility box. The core drill may have an inside diameter greater than a largest diameter across the lid. A utility box top may be positioned generally level with a level of the ground surrounding the drilled hole by performing one of the following: raising the utility box such that a top of the utility box is generally level with a level of the ground surrounding the drilled hole, inserting an extension into the utility box such that the utility box top is a top of the extension, or replacing the utility box with a replacement utility box such that the utility box top is a top of the replacement utility box.

At least some embodiments of the invention include a method for facilitating access to a utility box, including locating an underground utility box from above-ground. A hole is drilled in the ground above the utility box to gain access to the utility box, and a utility box top is positioned generally level with a level of the ground surrounding the drilled hole.

At least some embodiments of the invention include a system for facilitating access to a utility box. The system includes a locating system operable to locate an underground utility box from above-ground, including at least one of a ferrous metal locating device and a ground penetrating radar. The system further includes a drill operable to drill a hole in the ground above the utility box to gain access to the utility box, the drill having an inside diameter at least as large as a largest dimension across a lid of the utility box.

### BRIEF DESCRIPTION OF THE DRAWINGS

FIG. 1 shows a cross section of a curb box located over a pipeline in the ground;

FIG. 2 shows a portion of a coring process in accordance with embodiments of the present invention; and

FIG. 3 shows the curb box from FIG. 1 fitted with an extension.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

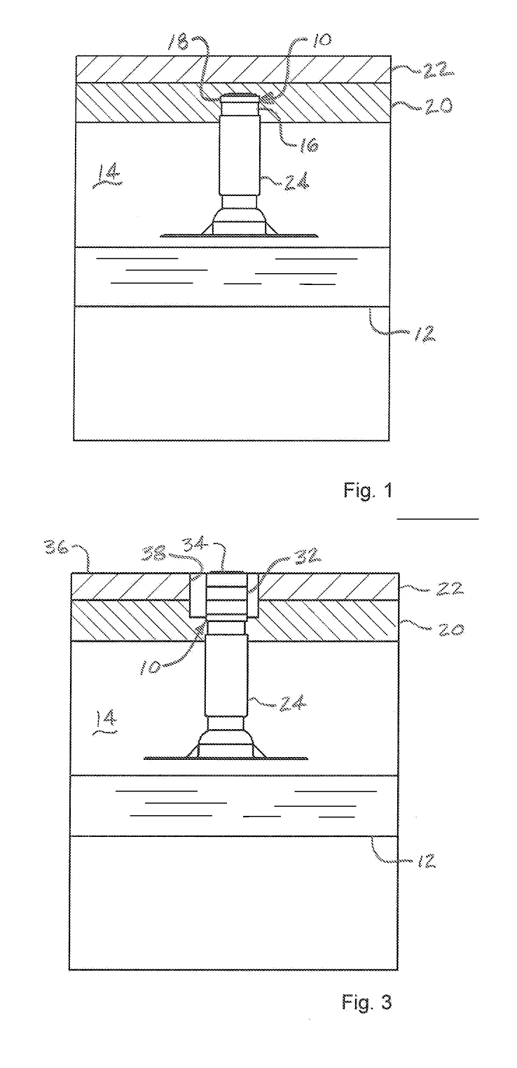

FIG. 1 shows a curb box 10 disposed in close proximity to a pipeline 12, which is buried in the ground 14. It is understood that any number of structures may be connected to the pipeline 12, with the curb box 10 providing access to them. For example, a service tee may be connected to the pipeline 12 and a shutoff valve or valves located within the curb box 10. Alternatively, a sacrificial anode may be buried in the ground 14, with an electrical connection between it and the pipeline 12 being terminated within the curb box 10.

The curb box 10 includes sidewalls 16, which may be a single cast piece, and lid, or cover 18, which is removable to allow access to an interior of the box 10. The curb box 10 is partially disposed within a concrete base 20 and a layer of asphalt 22 As shown in FIG. 1, the top 18 of the curb box 10 is completely covered by the asphalt 22, and in this case, is also covered by some of the concrete layer 20. An extender 24 extends downward from the curb box 10 through the concrete layer 20 and into the ground 14. This protects whatever connections extend upward from the pipeline 12 when the concrete 20 is poured.

As described above, embodiments of the present invention may include a number of steps to locate the curb box 10, which is below the asphalt 22, and therefore not visible. After obtaining an M&S map from the utility whose curb box is being located, a technician may use a ferrous metal locating device to narrow in on the location of the curb box in question. Once having gotten to within about a foot of the specific location of the curb box, a GPR system may be used as described above to pinpoint the curb box. Once having located the curb box, the method then accesses the box without a large, intrusive excavation project as described above.

FIG. 2 shows a drill bit, which in this embodiment is a core drill 26, attached to a high-torque drill 28, which itself is mounted on an adjustable stand 30. The stand 30 allows the drill 28 to be moved vertically during its operation. The inside diameter of the core drill 26 is sized to be somewhat larger than the largest dimension of the curb box 10 as viewed in a top plan view. In the case of a generally square box, the diagonal represents the largest dimension, and this determines the size of the core drill. For example, if the curb box 10 is 6 inches on a side, the diagonal is approximately 8.5 inches across. In such a case, the core drill 26 may be sized with an inside diameter of about 10 inches. The core drill 26 drills a circular perimeter around the top of the curb box 10, and once it has cut through the ground material—i.e., the asphalt 22 and the concrete 20—the curb box 10 can be raised as described above.

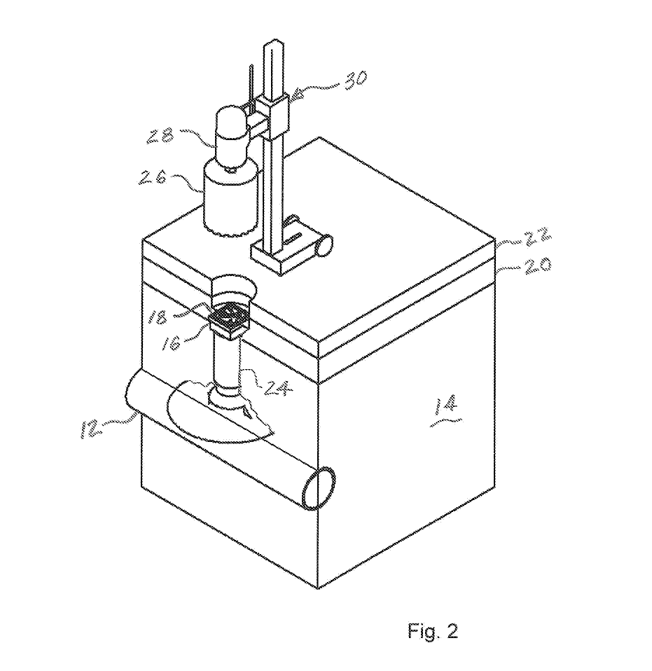

In one embodiment of the present invention, the existing curb box 10 is left in place and an extension added to it. This is illustrated in FIG. 3, which shows an extension 32 attached to the valve box 10. The extension 32 has a lid or cover 34, similar to the cover 18, but it will now be generally flush with the top surface 36 of the asphalt 22. In other embodiments, an existing curb box, such as the curb box 10, is removed and replaced with a new box that is cemented or grouted in place within a hole, such as the hole 38, left by the core drill 26. In other embodiments, an existing curb box, such as the curb box 10, can be raised so that the cover 18 is level with the top surface 36 of the asphalt 22.

In some embodiments, an extension is used, or a replacement curb box is used to replace the existing curb box. In cases, where the replacement box or extension is circular, a square hole may be cut out in the center of the circular box or extension so that a square cover, such as the covers 18, 34, can be used on the extension or circular box. In each case, grout may be used in the hole to secure the new box, the existing box that has been raised, or the extension. In addition, the top of the box—i.e., the top of the curb box that has been raised, the top of the extension that has been added to the existing curb box, or the top of the replacement curb box installed in place of the existing curb box—will be generally level with a level of the ground surrounding it, thereby facilitating access to the curb box.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for facilitating access to a utility box, comprising:
locating an underground utility box from above-ground, the utility box having a cover;
core-drilling a hole in the ground above the utility box to gain access to the utility box, the core drill having an inside diameter greater than a largest diameter across the cover; and
positioning a utility box top generally level with a level of the ground surrounding the drilled hole by performing one of the following:
raising the utility box such that a top of the utility box is generally level with a level of the ground surrounding the drilled hole,
inserting an extension into the utility box such that the utility box top is a top of the extension, or
replacing the utility box with a replacement utility box such that the utility box top is a top of the replacement utility box.

2. The method of claim 1, wherein the step of locating an underground utility box from above-ground includes using ground penetrating radar to determine a location of the utility box.

3. The method of claim 2, wherein the step of locating an underground utility box from above-ground includes using a ferrous metal locating device prior to using the ground penetrating radar.

4. The method of claim 1, wherein the step of locating an underground utility box from above-ground includes drilling at least one locating hole in the ground above the utility box prior to the step of core-drilling.

5. The method of claim 1, wherein the step of drilling a hole in the ground above the utility box to gain access to the utility box includes drilling with a core drill to cut a circular perimeter in the ground, and removing ground material inside the perimeter.

6. The method of claim 1, further comprising providing a grout material in the drilled hole.

7. A method for facilitating access to a utility box, comprising:
locating an underground utility box from above-ground;
drilling a hole in the ground above the utility box to gain access to the utility box; and
positioning a utility box top generally level with a level of the ground surrounding the drilled hole.

8. The method of claim 7, wherein the step of locating an underground utility box from above-ground includes using ground penetrating radar to determine a location of the utility box.

9. The method of claim 8, wherein the step of locating an underground utility box from above-ground includes using a ferrous metal locating device prior to using the ground penetrating radar.

10. The method of claim 7, wherein the step of locating an underground utility box from above-ground includes drilling at least one locating hole in the ground above the utility box prior to the step of drilling a hole in the ground above the utility box to gain access to the utility box.

11. The method of claim 7, wherein the step of drilling a hole in the ground above the utility box to gain access to the utility box includes drilling with a core drill to cut a circular perimeter in the ground, and removing ground material inside the perimeter.

12. The method of claim 11, the utility box having a lid, and wherein an inside diameter of the core drill is larger than a largest dimension across the utility box lid.

13. The method of claim 7, wherein the step of positioning a utility box top generally level with a level of the ground surrounding the drilled hole includes raising the utility box such that the utility box has a top that is generally level with a level of the ground surrounding the drilled hole.

14. The method of claim 7, wherein the step of positioning a utility box top generally level with a level of the ground surrounding the drilled hole includes inserting an extension into the utility box such that the utility box top is a top of the extension.

15. The method of claim 7, wherein the step of positioning a utility box top generally level with a level of the ground surrounding the drilled hole includes replacing the utility box with a replacement utility box such that the utility box top is a top of the replacement utility box.

16. The method of claim 7, further comprising providing a grout material in the drilled hole after the step of positioning a utility box top generally level with a level of the ground surrounding the drilled hole.

17. A system for facilitating access to a utility box, comprising:
a locating system operable to locate an underground utility box from above-ground, including at least one of a ferrous metal locating device and a ground penetrating radar; and
a drill operable to drill a hole in the ground above the utility box to gain access to the utility box, the drill having an inside diameter at least as large as a largest dimension across a cover of the utility box.

18. The system of claim 17, further comprising a core drill configured to cooperate with the drill such that the hole drilled in the ground is a circular perimeter.

19. The system of claim 17, further comprising an extension attachable to the utility box such that a top of the extension is generally level with a level of the ground surrounding the drilled hole.

20. The system of claim 17, further comprising a stand having the drill mounted thereon and linearly adjustable to move the drill vertically during operation of the drill.
